(19) United States
(12) Patent Application Publication
(10) Pub. No.: US 2005/0122835 A1
(43) Pub. Date: Jun. 9, 2005

(54) Stand Mixer chute assembly

(76) Inventor: Kay A. Nussbaum, Rowan, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/730,865

(22) Filed: Dec. 9, 2003

(51) Int. Cl. B01F 15/02

(52) U.S. Cl. 366/183.1; 366/197

(57) ABSTRACT

A stand mixer chute assembly is provided for introducing food ingredients into a bowl on a stand mixer. The chute assembly includes a body adapted to hold food ingredients and a leg to support the body on a countertop or table. The front edge of the body rests upon the upper perimeter edge of the bowl and into the bowl so that food ingredients may be fed into the bowl during operation of the stand mixer. A secondary body may be provided to matingly nest within the first body so that dry and liquid ingredients may be fed into the bowl using different chute bodies.

### BACKGROUND OF THE INACTION

Stand mixers are useful kitchen appliances for mixing food ingredients in a stationary bowl. In a conventional stand mixer, the mixer head is pivotally mounted on a base and includes a motor for rotating a tool, such as a beater, whisk, or bread hook. The tool is eccentrically mounted on the head for rotation about the mounting shaft of the tool, as well as rotation about the center axis of the head.

When the head is pivoted into the use position with the tool in the mixing bowl, there is relatively little clearance for introducing food ingredients into the bowl. This minimal clearance makes it difficult to add ingredients as the mixer is operating. One stand mixer manufacturer, KitchenAid, has tried to overcome this problem by providing an accessory which mounts on the top of the bowl and extends around the perimeter of the bowl, with a chute extending therefrom. The KitchenAid chute accessory includes an opening through which the tool extends, but otherwise substantially closes the top of the bowl, and thus limits access to the contents of the bowl without moving the accessory. Also, the bowl cannot be removed from the mixer stand until the accessory chute is removed, since the tool extends through the accessory, even when the head is pivoted upwardly, away from the use position.

Therefore, a primary objective of the present invention is the provision of a stand mixer chute assembly which can be quickly and easily set up to allow for the feeding of food ingredients into the mixing bowl of a stand mixer.

Another objective of the present invention is the provision of a stand mixer chute assembly having a primary body and a secondary body removably fit within the primary body, with the bodies receiving solid and liquid ingredients, respectively.

A further objective of the present invention is the provision of a stand mixer chute assembly having an adjustable height.

Still another objective of the present invention is the provision of a chute assembly for a mixing bowl wherein the forward edge of the chute has a projection to engage the bowl to prevent movement between the chute assembly and the bowl.

Another objective of the present invention is the provision of a method of feeding food ingredients from a chute into a mixing bowl.

Still another objective of the present invention is the provision of a chute assembly for a mixing bowl which is economical to manufacture and durable in use.

These and other objectives will become apparent from the following description of the invention.

### BRIEF SUMMARY OF THE INVENTION

The stand mixer chute assembly of the present invention includes a primary chute body adapted to hold food ingredients, and having a bottom wall, opposite side walls, a rear wall, and an open front edge. A leg supports the body so that the bottom wall is sloped downwardly towards the front edge, with the front edge adapted to overlap the upper edge of the mixing bowl. Thus, food ingredients placed in the chute may be fed into the bowl during operation of the stand mixer. A second chute body is adapted to matingly fit within the primary body such that one body may receive solid ingredients and the other body receive liquid ingredients. The leg is preferably telescoping so that the height of the body is adjustable. The leg is also removably mounted on the body or pivotally mounted to the body for movement between a folded storage position and an extended use position.

In the method of the present invention, the chute is set up adjacent the bowl with the front edge of the chute over the edge of the bowl. Food ingredients are deposited into the chute, and then fed by gravity or by scraping into the bowl while the mixer is operating.

### BRIEF DESCRIPTION OF THE DRAWINGS

FIG. 1 is a perspective view of the stand mixer chute assembly of the present invention positioned for use with a stand mixer and mixing bowl, and showing the primary and secondary bodies.

FIG. 2 is front elevational view of the combination of the stand mixer and chute assembly according to the present invention.

FIG. 3 is an elevational view of the chute assembly, with the support leg in a partially folded position.

FIG. 4 is an exploded elevational view showing an alternative removable leg for the chute assembly.

### DETAILED DESCRIPTION OF THE PREFERRED EMBODIMENT

The present invention is directed towards a chute assembly 10 for use with a stand mixer 12 and mixing bowl 14. The stand mixer 12 is provided with a tool 16, such as beater, whisk, or bread hook. The stand mixer 12, bowl 14 and tool 16 are conventional in construction and operation.

The chute assembly 10 includes a primary chute body 18 having a bottom wall 20, opposite side walls 22, and a back wall 24. The front edge 26 of the chute body 18 is open.

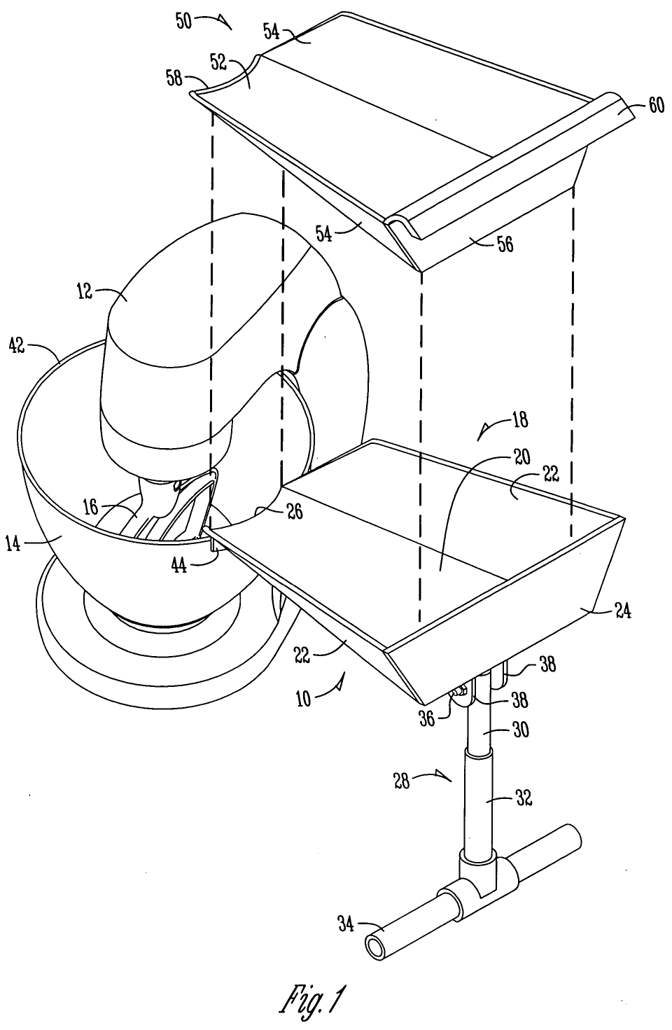

The chute body 18 is supported by aat least one leg 28. Preferably, the leg 28 includes telescoping sections 30, 32 and a base 34. The telescoping sections 30, 32 allow the height of the chute body 18 to be adjustable. As seen in FIGS. 1-3, the leg 28 is pivotally connected to the chute body 18 by a pin or bolt 36 extending through a pair of tabs or ears 38 extending downwardly from the bottom wall 20 of the chute body 18. Thus, the leg 28 can be folded to a storage position and extended to a use position. Alternatively, a leg 28A can be removably mounted in a socket 40 on the bottom of the chute body 18, as shown in FIG. 4. The alternative leg 28A can be removed for storage of the chute assembly 10.

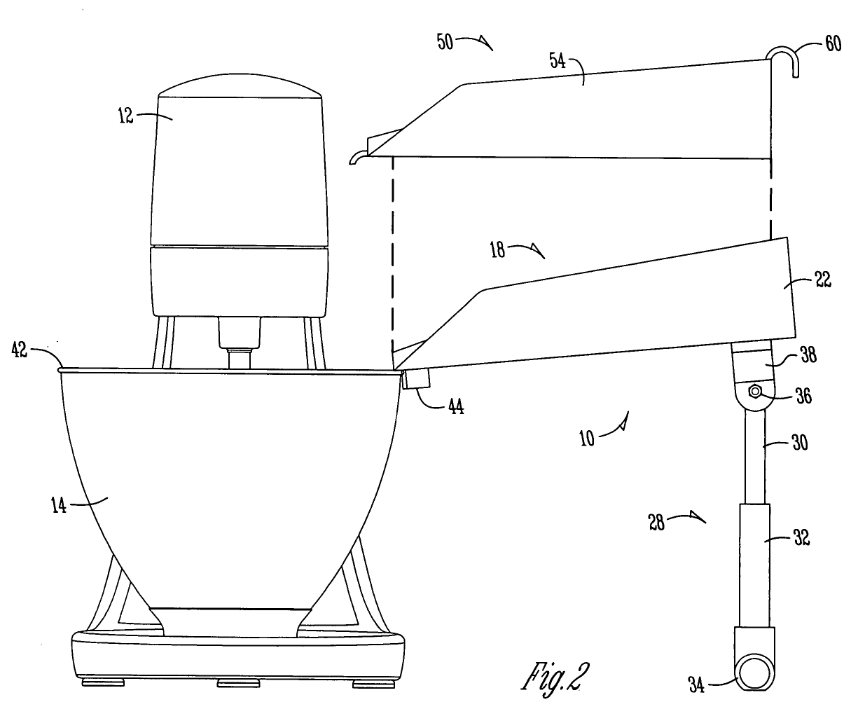

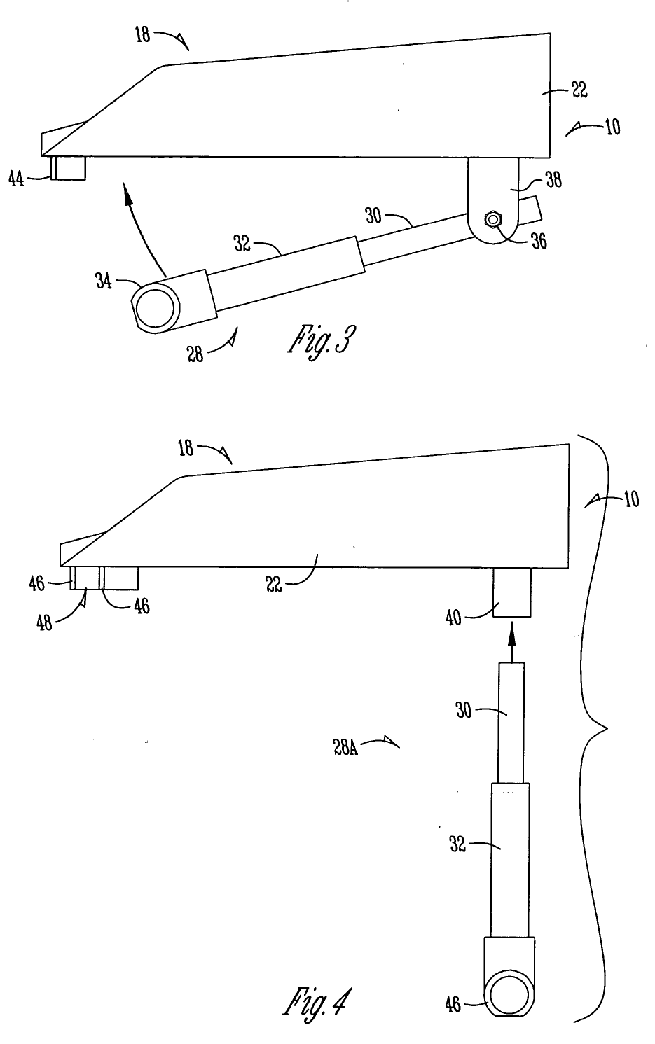

In use, the leg 28 is moved to the upright extended position, or the leg 28A is inserted into the socket 40, and the telescoping sections 30, 32 are adjusted to set the chute body 18 at the desired height. The front edge 26 of the chute body 18 rests upon the upper perimeter edge 42 of the bowl 14. As seen in FIGS. 2 and 3, a stop member 44 may be provided on the bottom wall 20 of the chute body 18 adjacent the front edge 26 to prevent the chute body 18 from sliding forwardly too far into the bowl 14. Alternatively, a pair of projections 46 may extend downwardly from the bottom wall 20 of the chute body 18 adjacent the front edge 26 so as to define a channel 48 so as to receive the perimeter edge 42 of the bowl 14. Thus, the projections 46 prevent the chute body 18 from moving forwardly or rearwardly relative to the bowl 14. The stop member 44 and projections 48 may have a short length or may be lengthened with a curvature to match the curvature of the bowl edge 42.

Three ingredients may be deposited in the chute body 18, and then scraped or pushed at the desired time into the bowl 14 for mixing by the tool 16 of the stand mixer 12, while the tool 16 is rotating. Thus, the chute body 18 will hold particulate ingredients until the user or cook is ready to mix them in the bowl 14.

As a further alternative, a secondary chute body 50 may also be provided. The secondary chute body 50 is adapted to be nested within the primary chute body 18. The secondary chute body 50 includes a bottom wall 52, opposite side walls 54, a rear wall 56, and an open front edge 58. The chute body 50 includes a rear hook 60 adapted to extend over the rear wall 24 of the primary body 18 so that the secondary chute body 50 is retained in primary chute body 18. The front edge 58 of the secondary chute body 50 extends slightly beyond the front edge 26 of the primary chute body 18. The secondary chute body 50 is used for liquid ingredients, while the primary chute body 18 is used for particulate or powder ingredients, or visa versa. Preferably, the primary chute body 18 is sloped slightly downwardly toward the front edge 26, so that liquid ingredients put in either of the chute bodies 18 or 50 will flow by gravity into the bowl 14.

It is understood that the exact structure of the chute assembly 10 may be modified from that which is shown in the drawings. For example, the chute bodies 18, 50 may have a curved cross sectional shape. Also, the leg 28 may take other shapes which provide stability to the assembly 10.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. A stand mixer chute assembly for introducing food ingredients into a bowl on a stand mixer, the bowl having an upper perimeter edge, the chute comprising:
a primary chute body adapted to receive the food ingredients and having a bottom wall, opposite side walls, a rear wall, and an open front edge; and
a leg to support the body so that the bottom wall is sloped downwardly towards the front edge, and the front edge is adapted to be supported by and overlap the upper edge of the bowl;
whereby food ingredients placed in the chute may be fed into the bowl during operation of the stand mixer.

2. The stand mixer chute assembly of claim 1 further comprising a secondary chute body adapted to fit within the primary body, and having front edge projecting beyond the front edge of the primary body, such that one of the bodies is adapted to receive solid ingredients and the other of the bodies is adapted to receive liquid ingredients.

3. The stand mixer chute assembly of claim 2 wherein the secondary body includes a hook to retentively engage the back wall of the primary body.

4. The stand mixer chute assembly of claim 1 wherein the leg is telescoping so as to adjust the height of the body.

5. The stand mixer chute assembly of claim 1 wherein the leg is pivotally mounted to the body.

6. The stand mixer chute assembly of claim 1 wherein the leg is removably mounted on the body.

7. The stand mixer chute assembly of claim 1 wherein the leg is movable between a folded storage position and an extended use position.

8. The stand mixer chute assembly of claim 1 wherein the body is a molded plastic.

9. The stand mixer chute assembly of claim 1 wherein the bottom wall has a lower surface with a stop element to prevent the body from moving relative to the edge of the bowl.

10. The stand mixer chute assembly of claim 1 wherein the bottom wall has a lower surface and a channel to receive the edge of the bowl and preclude movement of the body relative to the bowl.

11. A method of feeding food ingredients into a mixer bowl for mixing, the bowl having a perimeter edge, the method comprising:
setting up a chute on a counter or table adjacent the bowl;
placing a front edge of the chute over the edge of the bowl;
depositing food ingredients into the chute;
passing the food ingredients from the chute into the bowl.

12. The method of claim 11 further comprising elevating a rear portion of the chute so that the chute slopes downwardly toward the front edge.

13. The method of claim 12 wherein the food ingredients are scraped from the chute into the bowl.

14. The method of claim 12 wherein the food ingredients flow by gravity from the chute into the bowl.

15. The method of claim 11 further comprising supporting the chute on a leg.

16. The method of claim 15 further comprising adjusting the height of the leg.

17. The method of claim 11 further comprising placing a second chute inside the first chute, with one of the chutes receiving solid ingredients and the other of the chutes receiving liquid ingredients.

18. In combination with a mixing bowl, a food chute for feeding food ingredients into the mixing bowl, the bowl having an upper perimeter edge, the food chute comprising:
a first body for holding food ingredients, and
a leg mounted on the body for supporting the body on a counter or table at a height adjacent the edge of the bowl;
the body having a forward edge adapted to extending over the edge of the bowl so that food ingredients may pass into the bowl.

19. The combination according to claim 18 further comprising a second body adapted to fit within the first body so that different food ingredients may be put into each body.

20. The combination of claim 19 wherein the second body has a hook to retentively engage the first body.

21. The stand mixer chute assembly of claim 18 wherein the leg is telescoping so as to adjust the height of the body.

22. The stand mixer chute assembly of claim 18 wherein the leg is pivotally mounted to the body.

23. The stand mixer chute assembly of claim 18 wherein the leg is removably mounted on the body.

24. The stand mixer chute assembly of claim 18 wherein the leg is movable between a folded storage position and an extended use position.

25. The stand mixer chute assembly of claim 18 wherein the bottom wall has a lower surface with a projection to prevent the body from moving relative to the edge of the bowl.
